(19) United States
(12) Patent Application Publication
(10) Pub. No.: US 2025/0262478 A1
(43) Pub. Date: Aug. 21, 2025

(54) STRETCHING DEVICE

(71) Applicant: Charles Corry, Chicago, IL (US)

(72) Inventor: Charles Corry, Chicago, IL (US)

(21) Appl. No.: 18/650,480

(22) Filed: Apr. 30, 2024

Related U.S. Application Data
(63) Continuation-in-part of application No. 18/582,970, filed on Feb. 21, 2024, now abandoned.

(51) Int. Cl. A63B 23/035

(52) U.S. Cl. CPC A63B 23/0355; A63B 2208/0228

(57) ABSTRACT

A stretching device includes a base having a conduit that defines a channel, a back that is pivotable with respect to the base, and an actuator disposed within the conduit. The actuator may be a linear actuator having a piston that translates with respect to the channel and that is coupled to the back when the stretching device is in a pushing configuration and decoupled from the back when the stretching device is in a pulling configuration. A controller operably coupled to the actuator is configured to direct the actuator to extend and retract the piston. When the actuator is in the pushing configuration, extension of the piston causes a pivotal pushing motion of the back relative to the base, and, when the actuator is in the pulling configuration, the piston translates within the channel without causing pivotal motion of the back relative to the base.

### FIELD

The disclosure relates to a device used to assist in stretching, and to associated methods.

### BACKGROUND

Stretching devices are useful tools to assist users in performing one or multiple specific stretching maneuvers such as back stretches, leg stretches, foot stretches, and the like. Some such devices are manually operated fully via force exerted by the user. Other such devices are single-function devices intended for use in specialized environments such as therapeutic settings. Desirably, a multifunction stretching device usable in various environments could be provided.

### SUMMARY

Now disclosed is a stretching device that includes an actuator that is operable in either a pushing configuration or a pulling configuration at the option of the user. A user may operate the device to assist with numerous stretching operations. The device may be configured in some embodiments for unsupervised use in a residential environment. Desirably, the seat of the device is supportable by a floor surface when in use, to minimize the size of the device.

In one embodiment, the stretching device comprises a base having a conduit that defines a channel; a back, the back being pivotable with respect to the base; an actuator disposed within the conduit and having a piston that translates with respect to the channel, the piston being coupled to the back when the stretching device is in a pushing configuration and decoupled from the back when the stretching device is in a pulling configuration; and a controller operably coupled to the actuator, the controller configured to direct the actuator to extend and retract the piston, wherein, when the actuator is in the pushing configuration, extension of the piston causes a pivotal pushing motion of the back relative to the base, and wherein, when the actuator is in the pulling configuration, the piston translates within the channel without causing pivotal motion of the back relative to the base. Desirably, the seat is unsupported such that the seat is supported by a floor or ground surface when in use. The device may be provided in the form of a kit with one or more stretching accessories.

A stretching method in some cases involves use of the above-described device for stretching. In other cases, a stretching method may comprise providing a stretching device, the device having a base, a back pivotable with respect to the base, an actuator, and a controller operably coupled to the actuator, and a seat, the seat being unsupported, the device being operable in a pushing configuration in which a piston of the actuator is coupled to the back and causes a pivotal pushing movement of the back relative to the base, and a pulling configuration in which a piston of the actuator causes retraction of a portion of the device between the legs of a user, the seat being configured to accommodate such retraction; sitting on the seat of the device while the seat is resting on a floor or ground surface; and actuating the controller to cause a pushing or pulling stretch via either a pivotal pushing movement or a retraction.

### BRIEF DESCRIPTION OF THE DRAWINGS

FIG. 1 is a perspective view of a stretching device, the device being positioned in a pushing configuration and a piston of the actuator in a fully retracted position, the device resting on a floor surface.

FIG. 2 is a front elevation of the stretching device of FIG. 1.

FIG. 3 is a rear elevation of the stretching device of FIG. 1.

FIG. 4 is a first side view of the stretching device shown in FIG. 1.

FIG. 5 is a second side view of the stretching device shown in FIG. 1.

FIG. 6 is a top plan view of the stretching device shown in FIG. 1.

FIG. 7 is a bottom plan view of the stretching device shown in FIG. 1.

FIG. 8 is an exploded view of the stretching device shown in FIG. 1

FIG. 9 is a perspective view of the stretching device of FIG. 1 in a storage position.

FIG. 10 is a perspective view of the stretching device of FIG. 1 with the actuator in a pushing configuration and with the piston of the actuator being partially extended.

FIG. 11 is a perspective view of the stretching device of FIG. 1 with the actuator in a pulling configuration, with the seat pads removed, with an extension strap installed, and with the piston in a partially extended position.

FIG. 12 is a perspective view of the stretching device as shown in FIG. 10 but with the piston in a fully extended position.

FIG. 13 is a perspective view of the stretching device of FIG. 1 with a foot pad attachment for a plantar fasciitis stretch.

FIG. 14 is a front elevation of the foot pad attachment shown in FIG. 13.

FIG. 15 is a perspective view of the stretching device of FIG. 1 connected to a split stretch attachment.

FIG. 16 is a relatively enlarged perspective view of a controller of the stretching device of FIG. 1.

FIG. 17 is a front perspective view of another example stretching device, the device being positioned in a pushing configuration and a piston of the actuator in a partially extended position.

FIG. 18 is a front perspective view of the stretching device of FIG. 17 with the actuator in a pulling configuration and the piston in the fully retracted position.

FIG. 19 is a perspective view of the stretching device of FIG. 1 with a mounted massage gun.

FIG. 20 is a first perspective view of the bracket and straps shown in FIG. 19.

FIG. 21 is a second perspective view of the bracket and straps shown in FIG. 19.

FIG. 22 is a first perspective view of the stretching device of FIG. 1 with a mounted vibration device.

FIG. 23 is a second perspective view of the stretching device of FIG. 1 with a mounted vibration device.

FIG. 24 is a perspective view of the bracket in the configuration shown in FIG. 23.

FIG. 25 is a perspective view of the stretching device of FIG. 1 with a first embodiment of a heat and vibration pad.

FIG. 26 is a perspective view of the heat and vibration pad shown in FIG. 25.

FIG. 27 is a perspective view of the stretching device of FIG. 1 with a second embodiment of a heat and vibration pad.

FIG. 28 is a perspective view of the heat and vibration pad shown in FIG. 27.

FIG. 29 is a first partial view of the stretching device of FIG. 1 with an alternative hinge and with a stabilizer bar.

FIG. 30 is a second partial view of the stretching device of FIG. 1 with an alternative hinge and with a stabilizer bar.

### DETAILED DESCRIPTION

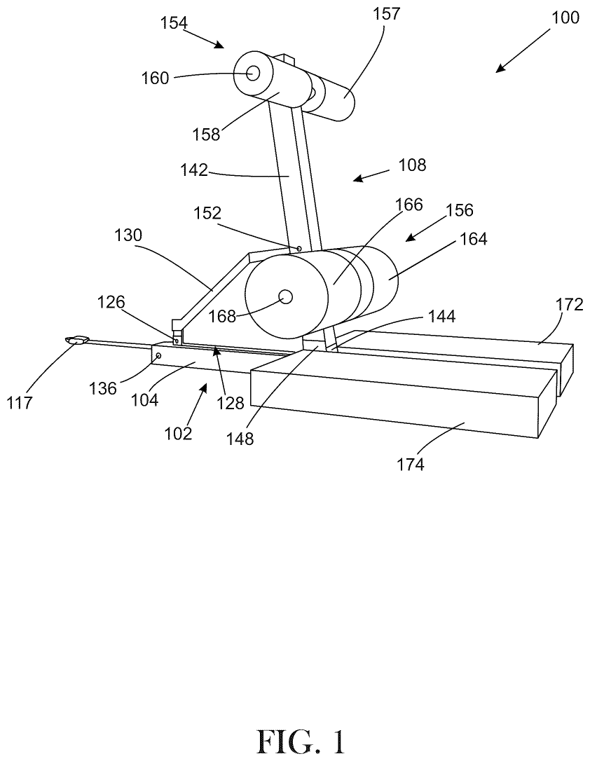

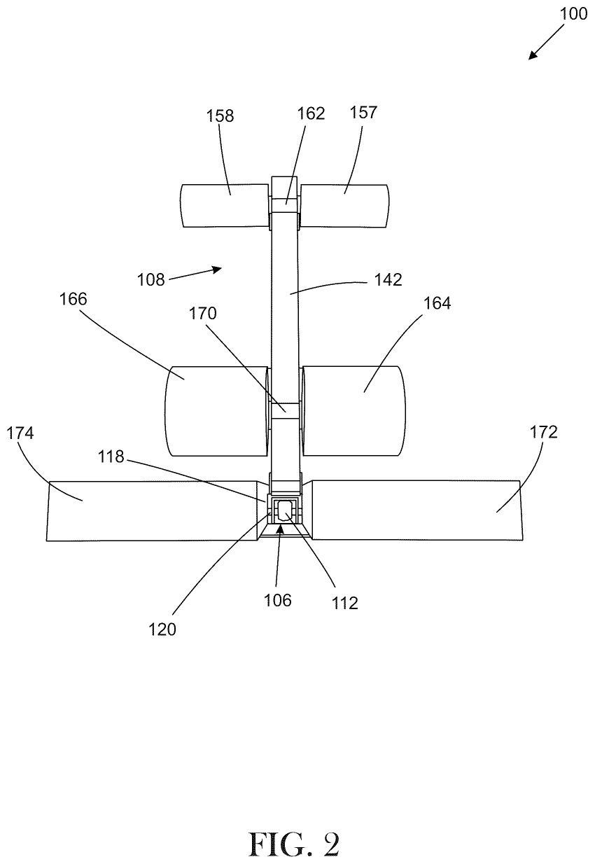

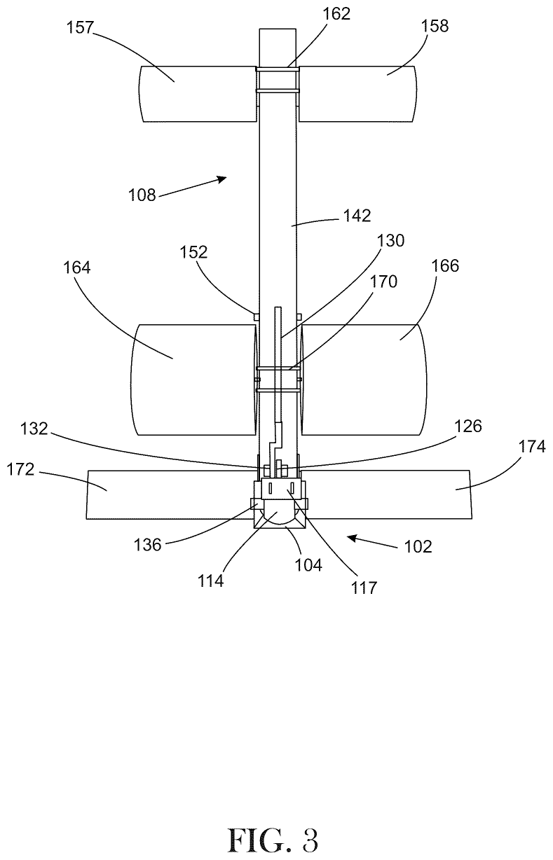

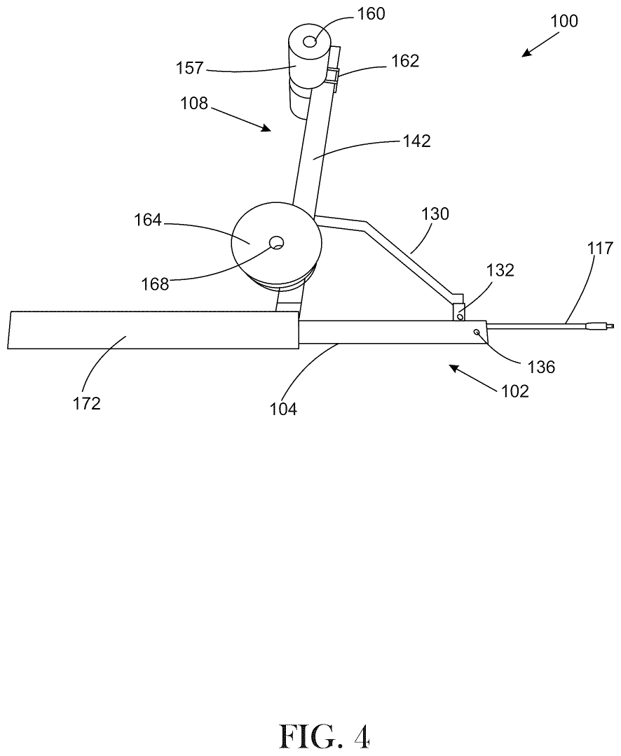

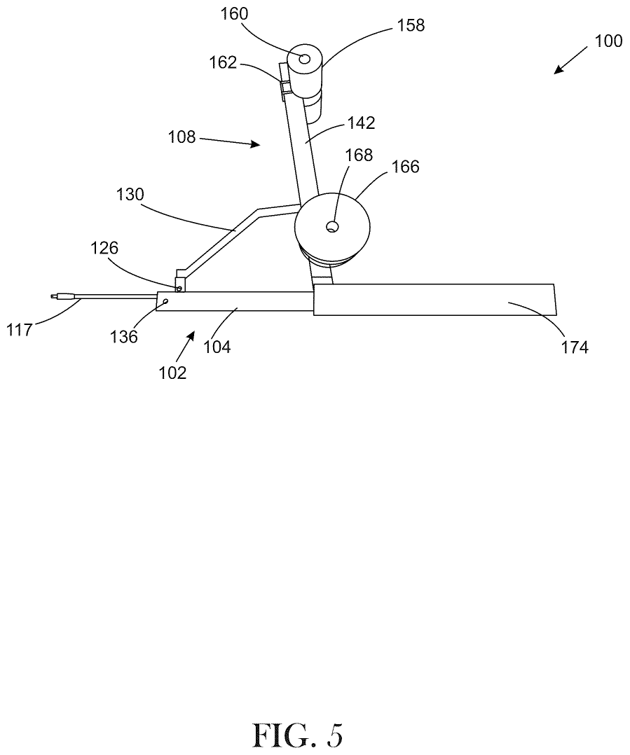

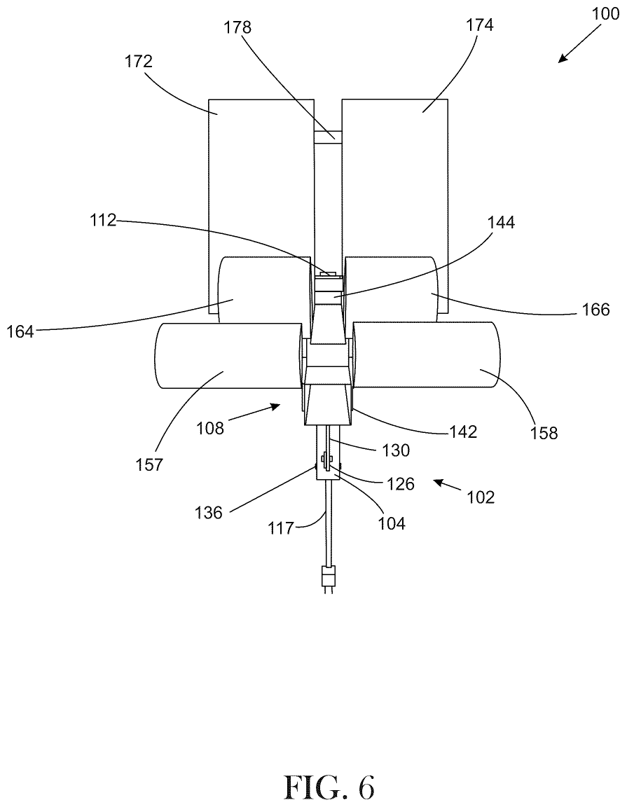

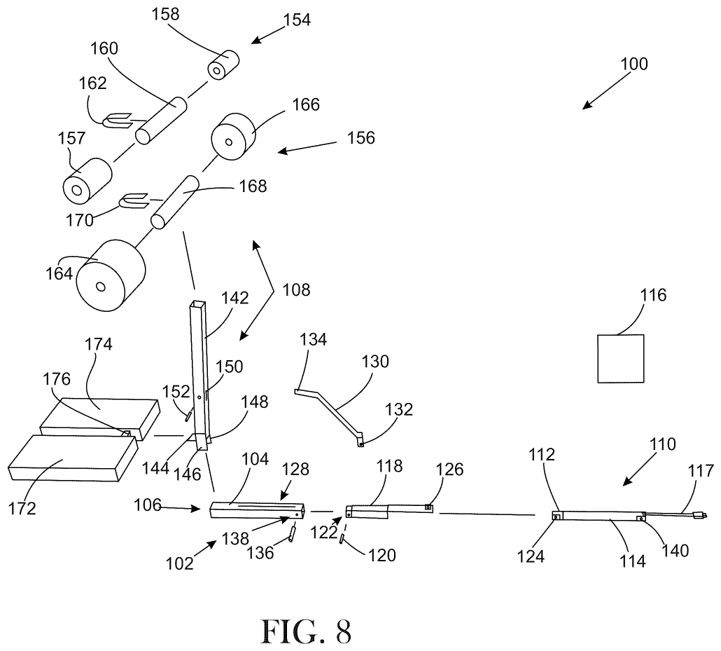

With reference to FIGS. 1-8, the illustrated stretching device 100 is modestly sized and is suitable for unsupervised use in a residential environment, but also may be used in a therapeutic environment such as a physical therapy office. The device includes a base 102 having a conduit 104 that defines a channel 106 (first shown in FIG. 2). The stretching device 100 also includes a back 108 that is pivotable with respect to the base 102 as described further hereinbelow. A linear actuator 110 (first shown in FIG. 8) is disposed within the conduit 104 and has a piston 112 (first shown in FIG. 2) that translates with respect to the channel 106 into and out of a housing 114 (first shown in FIG. 3) of the linear actuator 110.

The piston 112 is coupled to the back 108 when the stretching device 100 is in a pushing configuration and decoupled from the back 108 when the stretching device 100 is in a pulling configuration. In operation, when the stretching device 100 is in the pushing configuration, extension of the piston 112 causes pivotal motion of the back 108 relative to the base 102, and, when the stretching device 100 is in the pulling configuration, the piston 112 translates within the channel 106 without causing pivotal motion of the back 108 relative to the base 102. The “pushing” and “pulling” configurations denote the motion of the operative part of the device when in use, it being recognized that the piston may be advanced or retracted in either configuration.

The linear actuator need take no special form and any device capable of linear actuation of a piston, such as an electric or hydraulic actuator, may be employed. Illustrated is a mechanical linear actuator 110 that is supplied with power via a power conduit 117. The power conduit 117 can include a plug as shown for wired alternative current configured to interface with a U.S. 110/120V standard electrical outlet. Alternatively, the device may be configured for other power sources such as direct current power supply using a battery or transformer or other supply of direct current. A controller 116 (first shown in FIG. 8) is operably coupled to the actuator 110 and is configured to direct the linear actuator 110 to extend and retract the piston 112 into and out of the housing 114. The pushing and pulling motion can also be accomplished through one or more other actuators that are not linear.

The base 102 includes a carriage sleeve 118 (first shown in FIG. 2) disposed within the conduit 104. The carriage sleeve 118 is coupled to the linear actuator 110 when the stretching device 100 is in the pushing configuration and decoupled from the linear actuator 110 when the stretching device 100 is in the pulling configuration. In particular, the carriage sleeve 118 is coupled to the linear actuator 110 via a fastener 120 (first shown in FIG. 2). As shown, the fastener 120 is a removable pin that passes through an aperture 122 (first shown in FIG. 8) in the carriage sleeve 118 and an aperture 124 (first shown in FIG. 8) in the piston 112 to removably couple the linear actuator 110 to the carriage sleeve 118. The carriage sleeve 118 includes a rider 126. The rider 126 is captured in a slot 128 of the conduit 104. An arm 130 is connected at one end 132 to the rider 126 and at another end 134 to the back 108 (see FIG. 8).

When the piston 112 is coupled to the carriage sleeve 118, the arm 130 in turn couples the linear actuator 110 to the back 108 so that the linear translation of the piston 112 into and out of the housing 114 will cause the pivotable motion of the back 108 relative to the base 102. A central column 142 of the back 108 has formed therein a slot 150 (first shown in FIG. 8) that receives the end 134 of the arm 130, which is then secured to the central column 142 via a fastener 152. The linear actuator 110 is secured to the conduit 104 via a fastener 136. The fastener 136 is a pin that passes through an aperture 138 (first shown in FIG. 8) in the conduit 104 and an aperture 140 (first shown in FIG. 8) in the housing 114. Fasteners 120, 140, 152 may take other forms, such as bolts or screws.

The back 108 comprises the central column 142 and is coupled to the base 102 via a hinge 144 over the conduit 104. The central column 142 includes stabilizing legs 146 and 148 (first shown in FIG. 8) that form a flange that extends down from the central column 142 over sides of the conduit 104 to constrain the central column 142 as the back pivots.

The back 108 also includes an upper pad arrangement 154 and a lower pad arrangement 156 coupled to the central column 142. The upper pad arrangement 154 includes cylindrical pads 157 and 158 secured to a shaft 160. The shaft 160 is in turn secured to the central column 142 via a bracket 162 (first shown in FIG. 2). Similarly, the lower pad arrangement 156 includes cylindrical pads 164 and 166 secured to a shaft 168, which is secured to the central column 142 by another bracket 170 (first shown in FIG. 2). The cylindrical pads 164 and 166 can be the same size or larger or smaller than the cylindrical pads 157 and 158. In other embodiments, the back may be a solid or cushioned panel. In the illustrated embodiment, the cylindrical pads 164, 166 can be removed from the column and used as foam rollers.

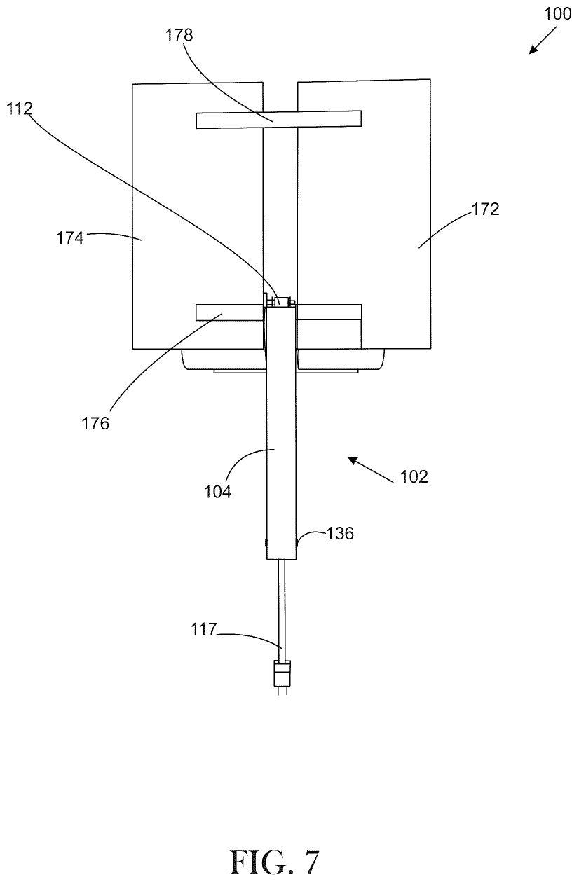

The stretching device 100 also includes a seat that comprises a first seating pad 172 and a second seating pad 174 that are removably coupled to the base 102. The first seating pad 172 and the second seating pad 174 are joined together via straps 176 and 178 (first shown in FIG. 7). The strap 176 assists in coupling the first seating pad 172 and a second seating pad 174 to one another and optionally to the conduit 104, and may be equipped with one portion of a hook-and-loop material to mate with another portion of hook-and-loop material on the conduit. The seating pads otherwise may be coupled via non-permanent adhesive, magnets, or another suitable fastening mechanism.

Notably, the device is constructed such that the seating pads 172, 174 are unsupported by any element of the device 100, excluding any incidental support if a portion of the pads contacts the base 102. Accordingly, the pads 172 and 174 will be supported at least in part by a floor surface if the device is positioned on the floor, or by the exterior ground surface if used in an exterior environment. This is advantageous when the device is intended for residential use because it allows the seat to be supported in part by the floor or ground surface, such that most of the user's weight is thereby supported. This arrangement obviates the need for additional support structures and therefore saving weight, complexity, and cost. In other embodiments, the device may be provided with support structures (not shown) for elevating the seat when in use.

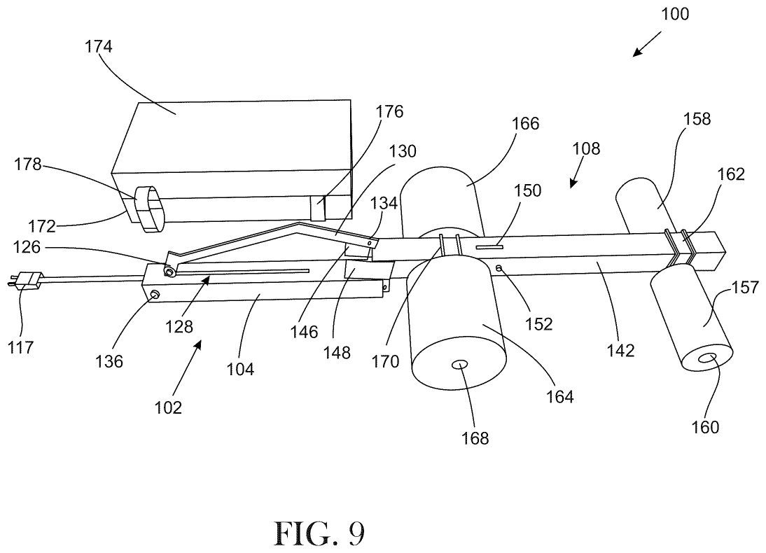

As shown in FIG. 9, the stretching device 100 can be folded into a storage position. When in the storage position, the first seating pad 172 and second seating pad 174 are decoupled from the base 102 and the end 134 of the arm 130 is decoupled from the central column 142 to enable the central column 142 to fold into an essentially flat orientation.

Alternatively, it is contemplated that the first and second seating pads 172, 174 might be replaced with one or more vibration plates. For example, each seating pad 172, 174 might be replaced with a vibration plate (or pad). It has been found that vibration elements help loosen the user's muscles and allow for a deeper stretch. These vibration plates may have the same removable and storable characteristics as mentioned above with respect to seating pads 172, 174.

Further, these vibration plates are capable of vibrating at different frequencies and amplitudes. It is generally contemplated that vibration plates may be selected having desired frequencies and amplitudes that provide certain advantages, such as, for example, helping to increase the flexibility of the user. For instance, these vibration plates could have a specific “stretching” setting, which would be configured to automatically set to the optimum frequency and amplitude for increasing flexibility. Optionally, rather than these vibration plates, a kit that includes the stretching device 100 might further include a hand-held vibration device for the user, which could also have the aforementioned “stretching” setting.

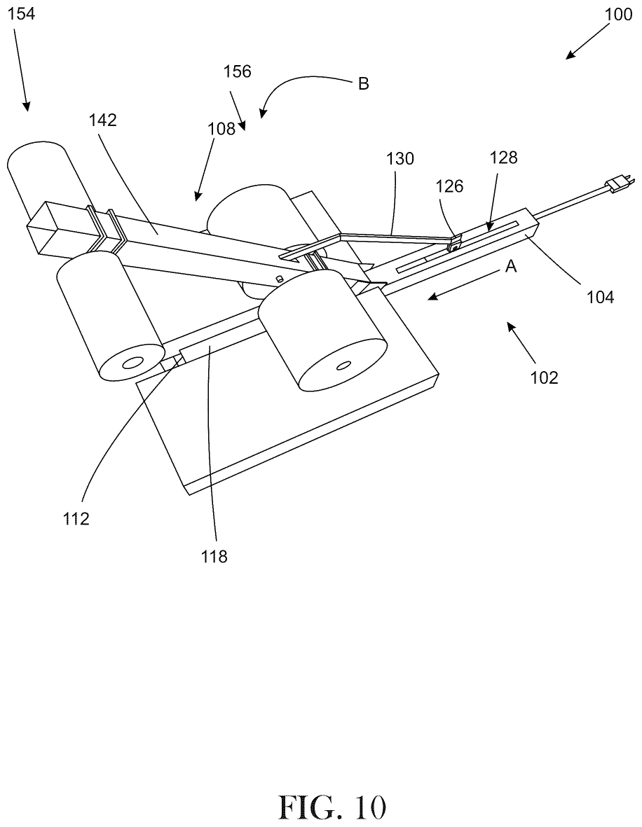

As shown in FIG. 10, the stretching device 100 is placed into the pushing configuration when the linear actuator 110 is coupled to the back 108 by coupling the piston 112 to the carriage sleeve 118. In this configuration, linear movement of the piston 112 in the direction A is translated into a pushing pivotal or rotational movement of the central column 142 along the line B via the arm 130 and movement of the rider 126 within the slot 128. The pivotal movement of the central column 142 is configured to cause the upper pad arrangement 154 and lower pad arrangement 156 to push against a back of a user sitting on the first seating pad 172 and second seating pad 174 to assist in performing a pushing-type stretch of the user's back. The slot 150 accommodates movement of the arm 130 as the back 108 pivots. The device thus assists the user in a back stretching operation. The upper and lower pad arrangements 154, 156 alternatively can be used to engage the legs or ankles of the user for a leg-type stretching operation.

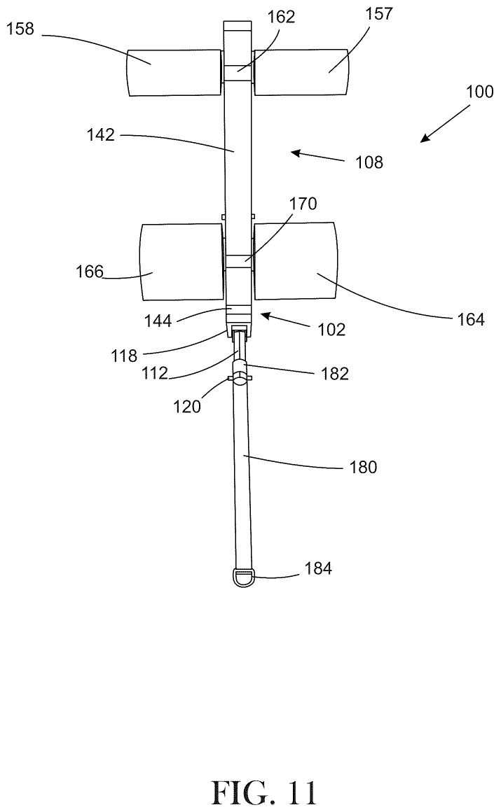

Turning now to FIG. 11, the stretching device 100 can be transitioned from the pushing configuration shown in FIG. 10 into the pulling configuration shown in FIG. 11 by decoupling the piston 112 from the carriage sleeve 118. The first seating pad 172 and second seating pad 174 optionally are removed temporarily to enable access to and removal or the fastener 120 to decouple the piston 112 from the carriage sleeve 118. In this position, the arm 130 no longer causes pivoting of the back 108 as the piston extends and retracts, but rather the piston extends and retracts within the carriage sleeve 118.

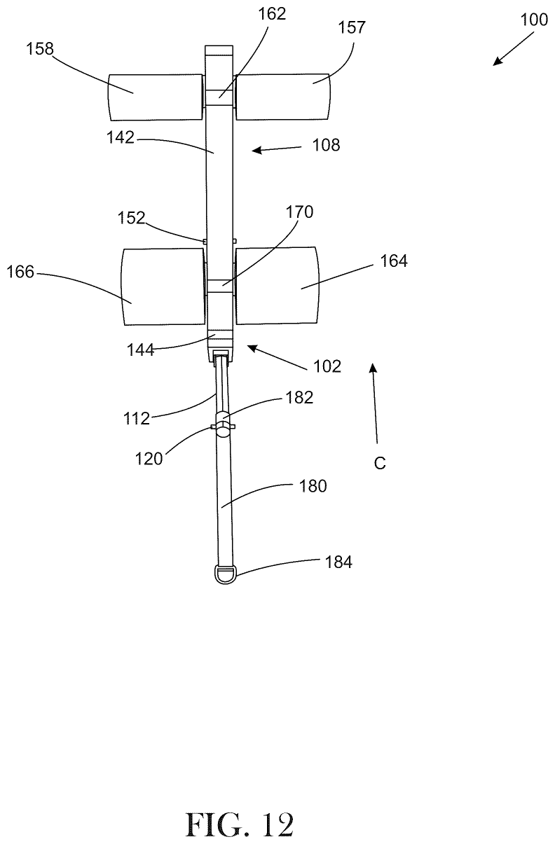

When in this pulling configuration, a portion of the device extends between the legs of the user. Specifically, a portion of the piston 112 so extends, and an extender such as extension strap 180 may if desired be coupled to the piston 112. As shown in FIG. 11, the extension strap 180 is fabric strip having a pocket or loop 182 at one end and an attachment ring 184 at the opposite end. The loop 182 is sized to fit snuggly around the piston 112 and is secured in place thereon by reinserting the fastener 120 into the piston 112 to oppose movement of the loop 182 off of the piston 112. The extension strap 180 can be secured to the piston 112 in other ways, and the extender can instead comprise a rigid or semi rigid extension bar or conduit (not shown) that couples to the piston 112 when the stretching device 100 is in the pulling configuration. The piston then may be extended to a more extended position such as the fully extended position shown in in FIG. 12, and will in this position be ready for mechanically assisted stretching operations by linearly retracting the piston 112 in the direction C. The retraction of the piston 112 operates in conjunction with a stretching accessory such as the one or more accessories described herein to provide different stretching operations for the user.

The piston 112 in this embodiment translates in a gap between the seat pads 172, 174. This again allows the seat pads to rest in part on a floor surface when in use. In other embodiments, a single seat pad could be equipped with a hollow channel (not shown) to accommodate translation of the piston, while still resting on the floor surface. The device need not be used on a floor or ground surface, and if desired the device may be used on a table or bench or otherwise in an elevated position, even though it is capable of use while resting on a floor surface.

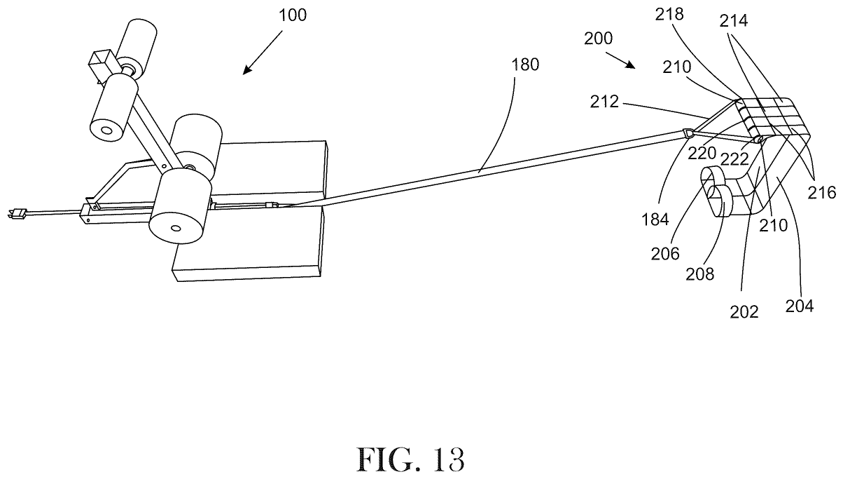

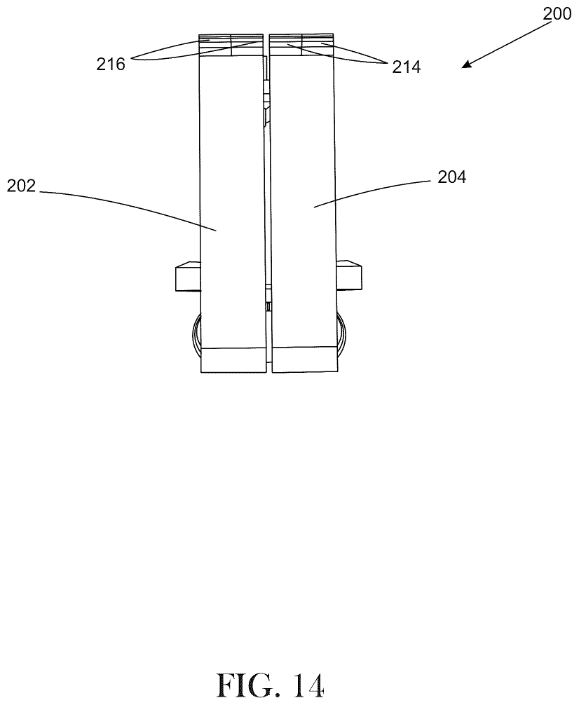

Turning now to FIG. 13, the stretching device 100 connects to a foot pad attachment 200 for use in the pulling configuration. The foot pad attachment 200 has a portion that retracts as the piston 112 retracts in the pulling configuration. The foot pad attachment 200 comprises a first foot retainer 202 and a second foot retainer 204 as shown in FIGS. 13 and 14. The first foot retainer 202 and second foot retainer 204 both include leg or ankle straps 206 and 208, respectively, for securing the feet of the user within the first foot retainer 202 and second foot retainer 204. A support bar 210 is pivotably coupled to both the first foot retainer 202 and second foot retainer 204 and is removably coupled to the attachment ring 184 of the extension strap 180 by a strap 212. Each foot retainer 202, 204 has two straps 214, 216 at the top, the straps 214, 216 sliding around the support bar 210. The support bar 210 has three retention rings 218, 220, 222 including first and second rings 218, 222 at each end and one central ring 220, which prevent the foot retainer straps from sliding laterally.

The two foot retainers 202, 204 can be used to stretch both feet at the same time or, if the user desires to stretch only one foot at a time, one foot retainer may be removed and the remaining foot retainer can slide to the middle of the support bar 210, with one of its two straps 214, 216 on one side of the middle retention ring 220 and the remaining strap on the opposing side of the retention ring 220. This assures that the foot retainer remains in the middle of the support bar 210, so that it pulls evenly on the single foot retainer. The support bar 210 also ensures that the stretching device pulls evenly across the entire span of the user's toes.

In operation of the device 100, the user first secures his or her feet to the first foot retainer 202 and second foot retainer 204 using the leg or ankle straps 206 and leg or ankle straps 208. Then, the piston 112 is retracted in the direction C as shown in FIG. 12 to pull the strap 180 and excerpt a pulling force on the user's feet as secured within the first foot retainer 202 and second foot retainer 204, thereby causing a plantar fasciitis stretch. The user's legs are kept as straight as practicable during this operation. If the user desires to cease the stretching operation, the user may extend the piston to remove the pulling force. In an emergency situation, such as loss of power, the user may bend his or her knees to extricate the user from the device.

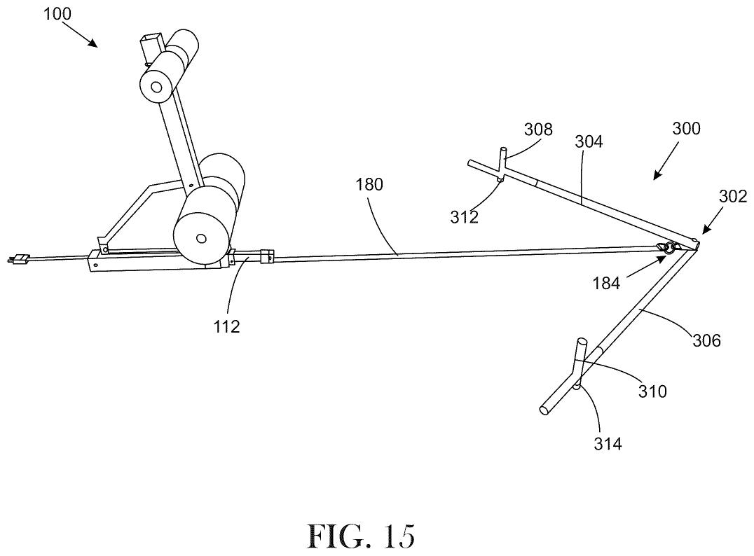

Turning now to FIG. 15, the stretching device 100 connects to a split stretch attachment 300 for use in the pulling configuration. Like the foot pad attachment 200, the stretch attachment 300 has a portion that retracts as the piston 112 retracts. In particular, the stretch attachment 300 includes a pivot point 302, a first arm 304 coupled to the pivot point 302, a second arm 306 coupled to the pivot point 302, and first and second retainers 308, 310 connected respectively to the first and second arms 304, 306. Each of the first and second retainers 308, 310 include discs 312 and 314, respectively, positioned on a bottom thereof, which allows the first and second arms 304, 306 to slide easily along any flooring surface. The pivot point 302 is removably coupled to the extension strap 180 via the attachment ring 184.

In operation, the user secures the user's legs to the arms 304, 306 by placing his or her ankles adjacent the first and second retainers 308, 310. Once secured, the piston 112 is retracted in the direction C as shown in FIG. 12 to pull the strap 180 and excerpt a pulling force on the pivot point 302. The strap 180 and a portion of the piston retract between the legs of the user. The pivot point 302 converts this pulling force from retraction of the piston 112 at least partially into a pivoting motion of the first arm 304 and the second arm 306 around the pivot point 302 to stretch the user's legs that are secured to the first and second arms 304, 306. Again, the user may cease the stretching operation and disengage from the device by retracting the piston or by bending the user's knees.

The stretching device 100 may be returned to the pushing configuration by first removing the fastener 120, sliding the loop 182 off of the piston 112, aligning the piston 112 and the carriage sleeve 118 (e.g., by retracting or extending the piston 112 and/or sliding the carriage sleeve 118), and reinserting the fastener 120 through the aperture 122 and the aperture 124 to resecure the piston 112 to the carriage sleeve 118. The stretching device 100 can also be transitioned to the storage position from the pulling configuration decoupling the end 134 of the arm 130 from the central column 142 by removing the fastener 152. Recoupling the piston 112 to the carriage sleeve 118 is desirably also performed because this can secure the carriage sleeve 118 within the conduit 104 when the stretching device 100 is in the storage position.

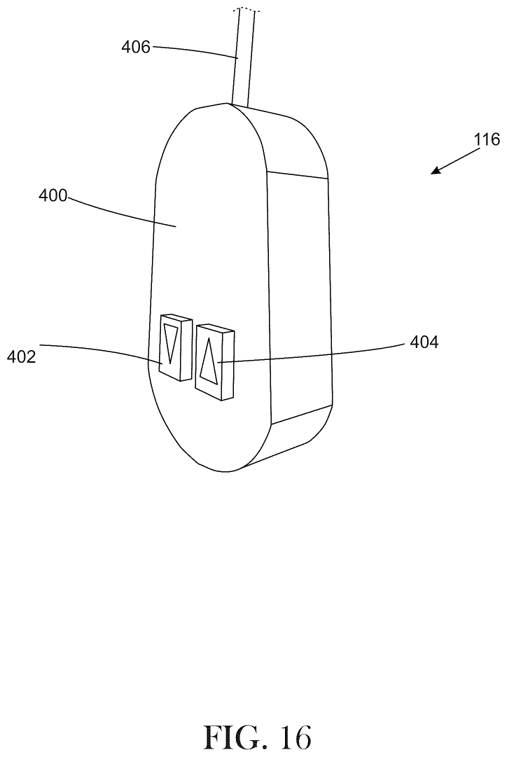

With reference now to FIG. 16, the controller 116 includes a housing 400 having an extend button 402 and a retract button 404 included therein and an electrical connector 406 for communicating with the linear actuator 110 (connection not shown). In operation, continual depression of the extend button 402 causes the linear actuator 110 to extend the piston 112 out of the housing 114 until a maximum extension is reached or the extend button 402 is no longer being depressed and continual depression of the retract button 404 causes the linear actuator 110 to retract the piston 112 into the housing 114 until the piston 112 is fully retracted or the retract button 404 is no longer being depressed. The actuator or controller may be provided with a stop limit mechanism for the fully extended or retracted positions. As shown in FIG. 16, the electrical connector 406 is a wired electrical connection to the linear actuator 110, but wireless connections may be employed. In some embodiments, the linear actuator 110 can be controlled solely or additionally by remote software, such as a software application that operates on a mobile telephone or other computing device (not shown). Via direct or networked communication, such software may interface with the controller 116 or may interface with communication circuitry and processors of the linear actuator 110. The controller 116 alternatively can be configured such that a single press of the extend button 402 and/or retract button 404 rather than a continual depression thereof will cause extension or retraction of the piston 112 to the limit of the range of travel of the piston 112.

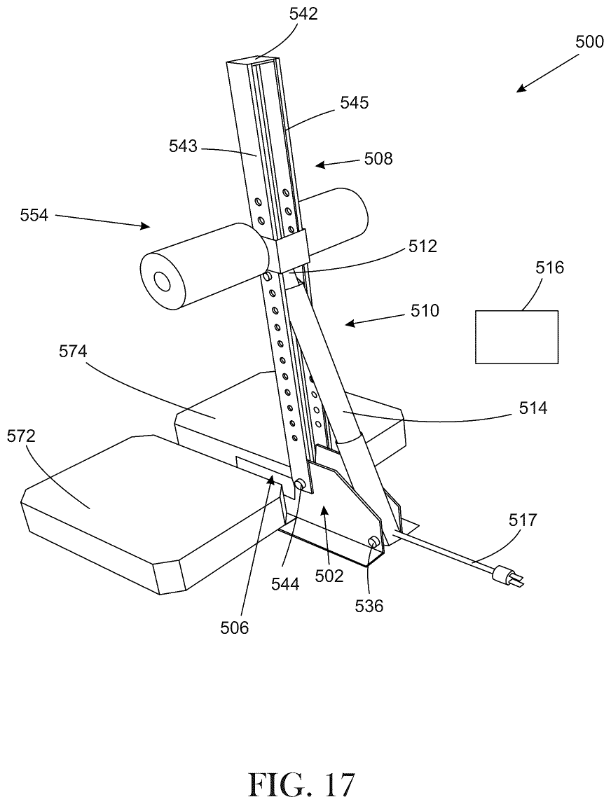

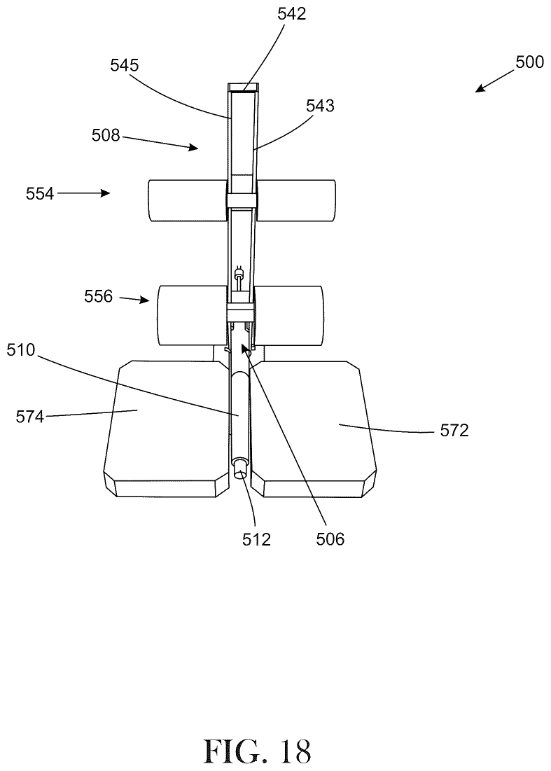

Regarding the alternative stretching device 500 shown in FIGS. 17 and 18, this includes a base 502, a back 508, a linear actuator 510, and a controller 516. The device 500 also includes a first seating pad 572 and second seating pad 574 removably coupled to the base 502.

The back 508 is pivotable with respect to the base 502 via a hinge or pivot 544. The back 508 comprises a central column 542 that is formed from two parallel plates 543 and 545 and pivots in response to movement of a piston 512 of the linear actuator 510. An upper pad arrangement 554 and a lower pad arrangement 556 are coupled to the central column 542.

The linear actuator 510 has a housing 514 pivotably coupled to the base 502 via a fastener 536. The piston 512 is configured for coupling to the back 508 when the alternative stretching device 500 is in a pushing configuration (FIG. 17) and configured for decoupling from the back 508 and positioning within a channel 506 of the base 502 when the alternative stretching device 500 is in a pulling configuration (FIG. 18). The linear actuator 510 also includes a power source 517.

Like the controller 116, the controller 516 is configured to direct the actuator 510 to extend and retract the piston 512 from the housing 514. When the 500 is in the pushing configuration shown in FIG. 17, operation of the actuator 510 causes pivotal motion of the back 508 relative to the base 502. When the alternative stretching device 500 is in the pulling configuration as shown in FIG. 18, operation of the actuator 510 causes relative linear motion of the piston 512 within the channel 506. Furthermore, when in the pulling configuration as shown in FIG. 18, the piston 512 can be coupled to the foot pad attachment 200 and the stretch attachment 300 via the extension strap 180 or similar coupler. In other respects, the features and functions of the device 500 may be the same as for device 100.

The stretching device 100 or the alternative stretching device 500 can be provided in a kit with the extension strap 180, the foot pad attachment 200, and/or the stretch attachment 300, and optionally other attachments useful for other stretching operations.

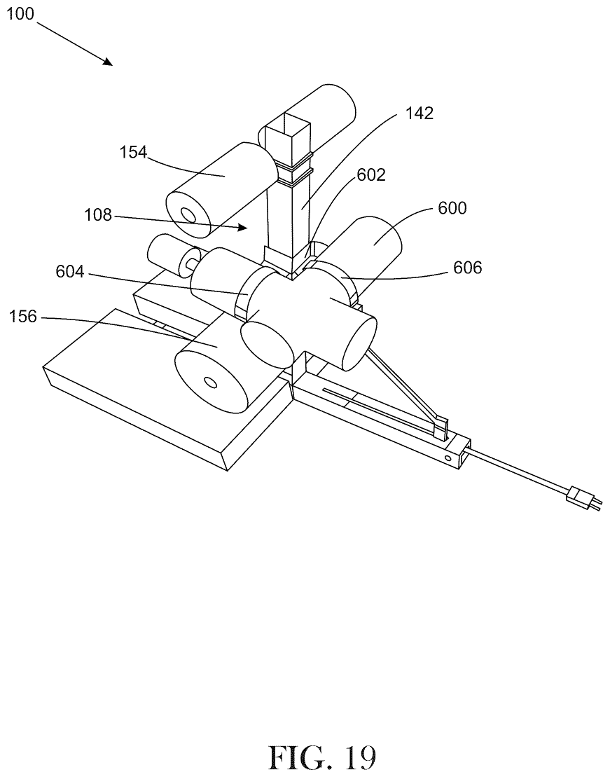

Other optional attachments that may be provided in a kit, alone or in addition to other attachments, are shown in FIGS. 19-28 and are described below. For example, the kit may include a bracket that allows for mounting of a massage device, such as a massage gun 600 or vibrating massager 620, to the stretching devices 100 or 500. The massage gun connotes a reciprocating massage device, with or without vibration, while the vibrating massager vibrates but does not reciprocate. In addition, or alternatively, the kit may include a heat and vibration pad 700 or 800 that may be attached, or mounted on, the stretching devices 100 and 500.

FIG. 19 shows a massage gun 600 that has been mounted to the stretching device 100. A bracket 602 is attached to the back 108 to facilitate mounting of the massage gun 600. It is generally contemplated that bracket 602 is removably attached to the central column 142, although the bracket 602 may be more permanently affixed. As can be seen, two straps 604 and 606 straps are attached to the bracket 602 and are adjustable to hold the massage gun 600 in position relative to the stretching device 100. The bracket 602 is preferably attached to the central column 142 of the back 108. More specifically, the bracket 602 is preferably attached to the central column 142 between the upper pad arrangement 154 and the lower pad arrangement 156 and may be adjustably positioned, as desired, relative to the body of the user.

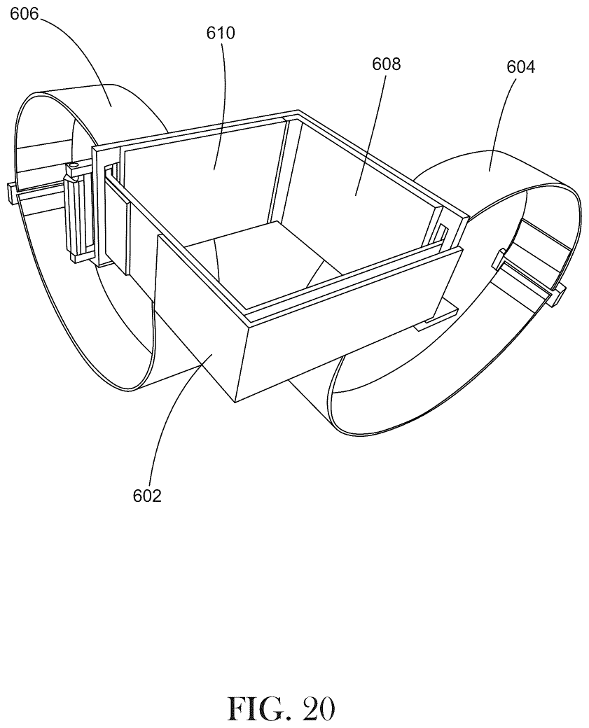

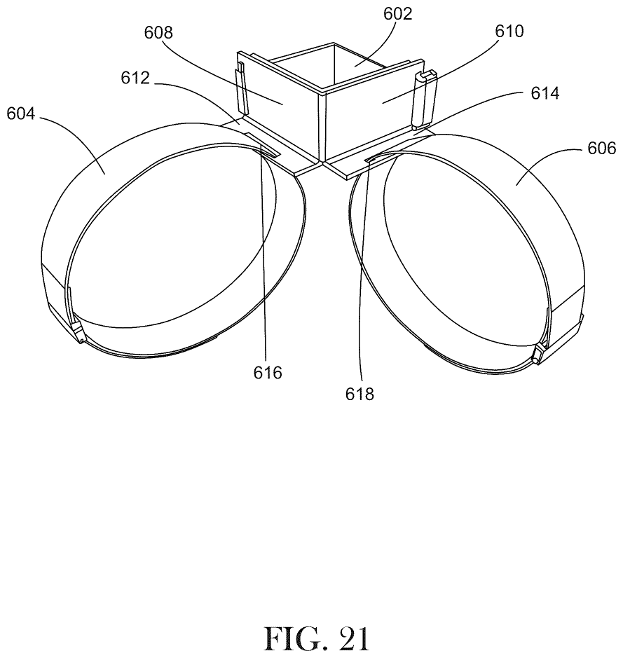

With reference to FIGS. 20 and 21, the bracket 602 is shown when not mounted to the stretching device 100. The bracket 602 is configured so that it can be firmly and securely mounted about the outside of the central column 142. The bracket 602 may be in the form of a universal mounting bracket. The bracket 602 may be adjustable in size so as to fit about the central column 142.

The illustrated bracket 602 includes two fixed sides 608 and 610. Each fixed side 608 and 610 includes a base flange 612 and 614 extending outwardly from that fixed side 608 and 610. The base flanges 612 and 614 each include a slot 616 and 618 therethrough. First base flange 612 includes a first slot 616 for receiving the first strap 604 therethrough, and second base flange 614 includes a second slot 618 for receiving the second strap 606 therethrough. The straps 604 and 606 are preferably removable from the bracket 602 and adjustable in diameter so as to accommodate different types and sizes of massage guns 600.

In use, this feature allows a user to access different areas on the user's back with the massage gun 600. The bracket 602 may hold many different types and sizes of massage guns 600, so that the user can sit on the stretching device 100 and have the massage gun 600 massage his or her back, without the need for another person to hold the massage gun 600. The stretching device 100 may also apply increased pressure to the massage gun 600, when the controller 116 is actuated to adjust and move the seat back 108.

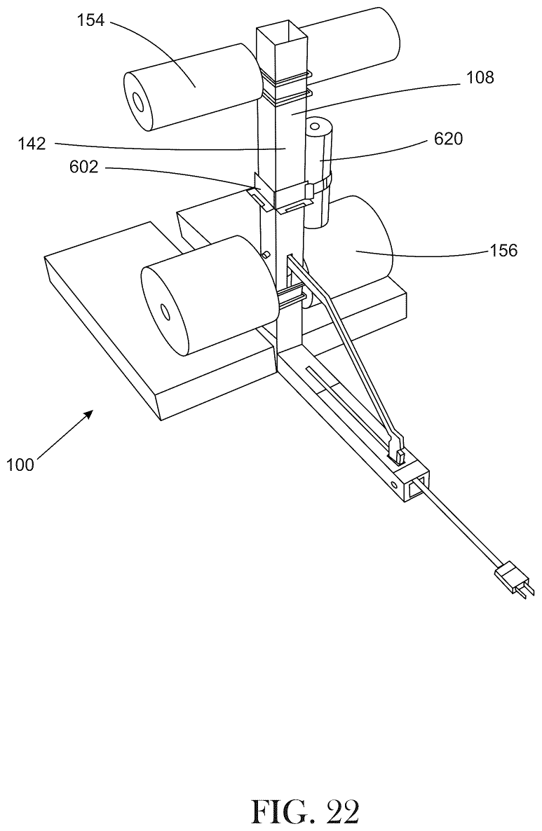

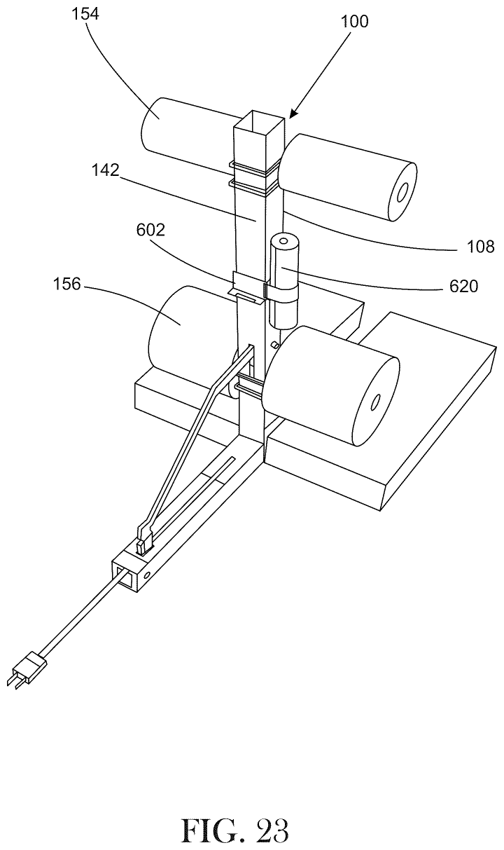

As shown in FIGS. 22 and 23, this bracket 602 may also be used to hold a

vibrating massager 620 (although a separate bracket may be used). FIGS. 22 and 23 show the vibrating massager 620 mounted to the central column 142 of the stretching device 100. In use, the vibrating massager 620 causes the central column 142 and back 108 to vibrate, thus further relaxing the user as he or she stretches.

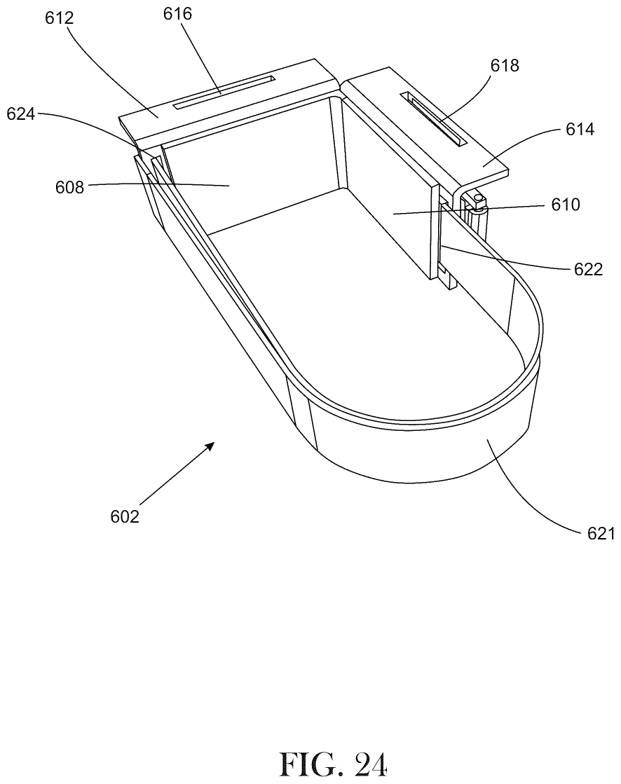

With reference to FIG. 24, the bracket 602 is shown in a configuration for holding the vibrating massager 620 (and without the straps 604 and 606). As can be seen, the bracket 602 can be shifted between a first configuration for mounting the massage gun 600 (shown in FIGS. 20 and 21) and a second configuration for mounting the vibrating massager 620 (shown in FIG. 24). In the first configuration, the bracket 602 is disposed about and engages the central column 142. In the second configuration, the bracket 602 is disposed about and engages both the central column 142 and the vibrating massager 620, thereby holding the vibrating massager 620 against the central column 142.

The bracket 602 includes an extendable portion 621 to allow movement of the bracket 602 between the first and second configurations. In FIG. 24, the bracket 602 has been extended from the first configuration to occupy the second configuration. The fixed sides 608 and 610 may form a right angle with respect to one another. The first fixed side 608 includes a recess 622 for receiving an end of the extendable portion 621. The second fixed side 610 includes a slot 624, located at the end opposite from the first fixed side 608, for receiving extendable portion 621. As can be seen, the size of the bracket 602 may be adjusted between the first and second configurations.

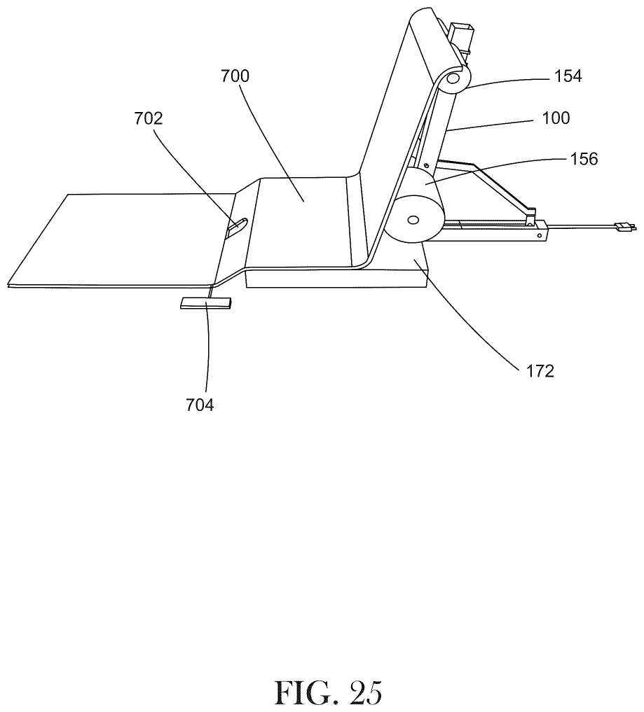

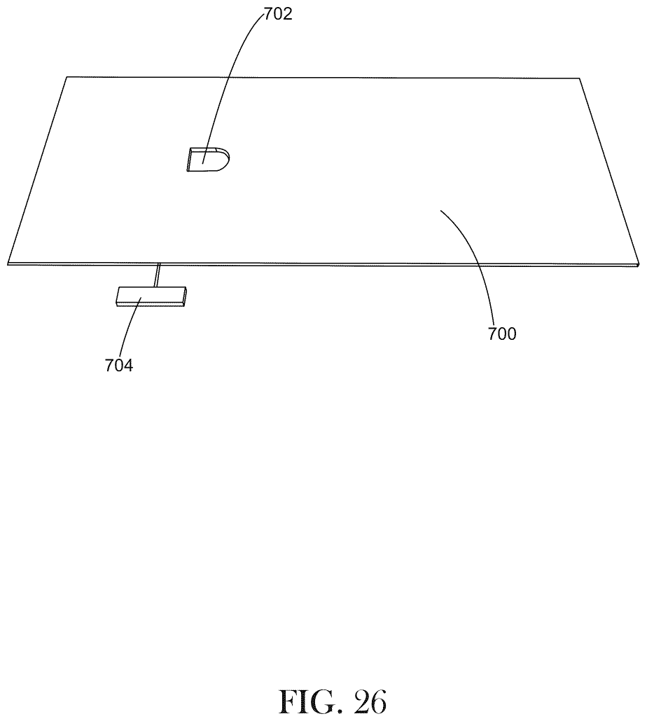

Another optional feature is shown in FIGS. 25 and 26. This feature is a heat and vibration pad 700 that can be mounted on the stretching device 100 (or the alternative stretching device 500). It has been found that the application of heat to muscles aids in stretching those muscles, and the vibration of muscles (such as by a pad 700) also aids in stretching of those muscles. The pad 700 may engage the legs and back of a user and allow the application of heat to those areas. The illustrated pad 700 is removably mounted to the stretching device 100 (or alternative stretching device 500). The pad alternatively may be permanently or semi-permanently attached to the stretching device 100 (or alternative stretching device 500). The cutout 702 is sized to accommodate extension strap 180. Further, as shown in FIG. 25, the pad 700 is generally flat and flexible so that it can be positioned to overlie the seating pads 172 and 174 and to engage the upper pad arrangement 154 and the lower pad arrangement 156. One end of the heat and vibration pad 700, when mounted, preferably extends over the upper pad arrangement 154.

The pad 700 may be powered by a battery power bank 704. Alternatively, or in addition, it may be powered through a USB plug or other plug into a wall outlet. It is contemplated that the pad 700 may have the ability to vibrate in specific areas or over the entire surface of the pad 700. This pad 700 may also have the ability to heat specific areas of the pad 700 or to heat the entire surface of the pad 700. A pad controller may allow the activation and control over the heat and/or vibration.

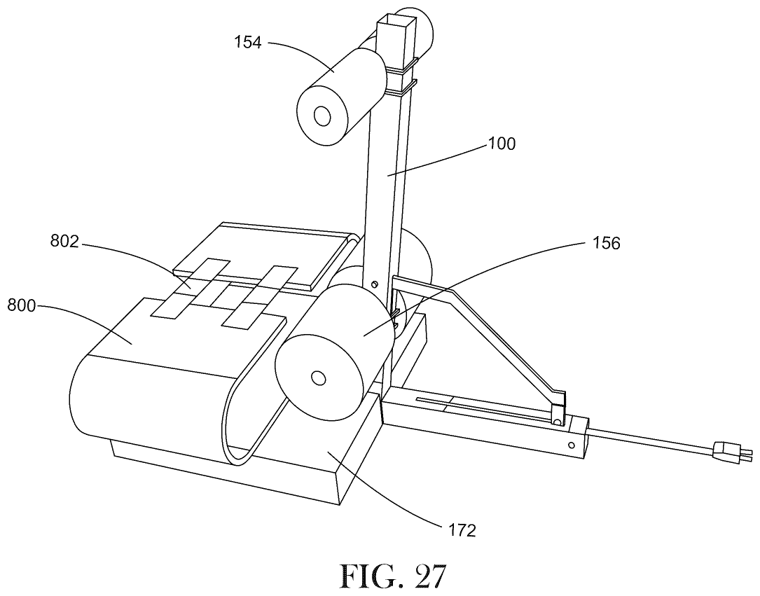

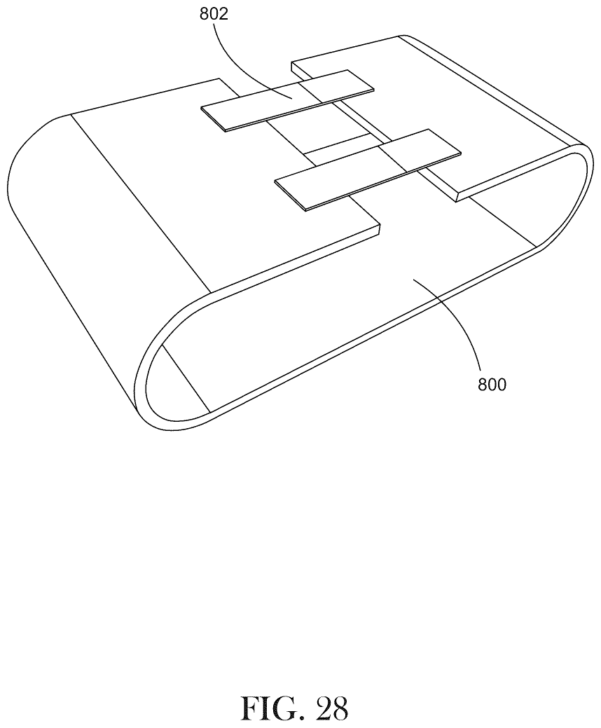

An alternative heat and vibration pad 800 is shown in FIGS. 27 and 28. This pad 800 is a different shape such that it can be wrapped around the user's legs. It includes straps 802 on top of the pad 800 that hold it around the user's legs. The pad 800 is generally flat but is flexible such that the ends of the pad 800 can be held together by straps 802. The straps 802 allow for adjustment of the pad 800 such that the user can increase or decrease the cross-sectional area of the pad 800. The user can move the pad 800 to different areas of the user's legs, and possibly to different areas of the user's body.

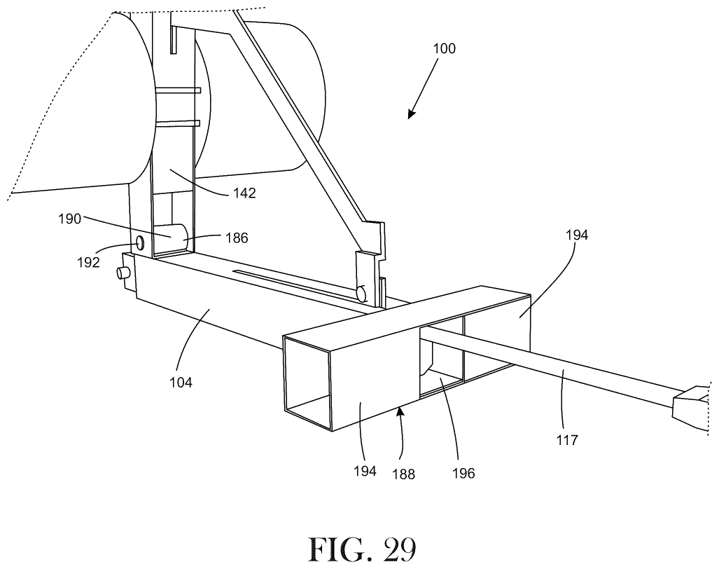

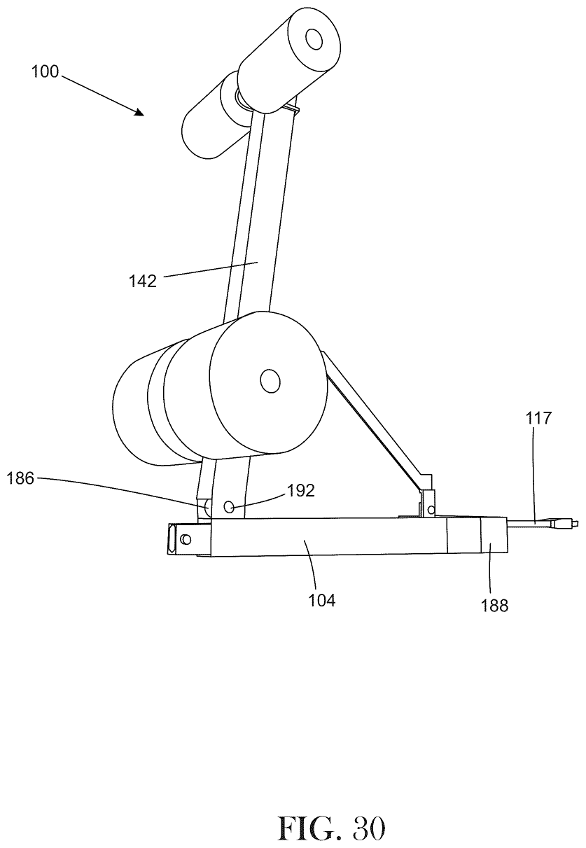

It is also contemplated that the stretching device 100 (and stretching device 500) may include other optional features that may provide additional support to the device 100. FIGS. 29 and 30 show an alternative hinge mechanism 186 and a stabilizer bar 188 used with stretching device 100. The alternative hinge mechanism 186 is preferably in the form of a relatively thick cylinder 190 with a pin 192 extending therethrough, although other hinge types are also possible. It is contemplated that hinge mechanism 186 will provide a robust folding connection between conduit 104 and central column 142, thereby leading to extended life and use of the stretching device 100.

Optionally, the stretching device 100 (and stretching device 500) may also include a stabilizer bar 188. As can be seen from the figures, the stabilizer bar 188 is preferably disposed at the rear of the stretching device 100 at or near one end of conduit 104. It preferably includes two legs 194 that each extend in a direction generally perpendicular to the conduit 104, and they help prevent the stretching device 100 from overturning due to external forces. The stabilizer bar 188 may have a rectangular cross-section and may also include an opening 196 that allows the power conduit 117 to extend through the bar 188. As should be understood, other shapes, sizes, cross-sections, and locations for the stabilizer bar 188 relative to device 100 are possible.

A stretching method involves use of the stretching device 100 and/or the alternative stretching device 500 in a pushing configuration to enable a back or leg stretch or other suitable stretch, or use of the device in a pulling configuration to enable a plantar fasciitis or split-leg stretch or other suitable stretch. The method may involve beginning with the device in one configuration (pushing or pulling), performing a suitable stretching operation with the device in that configuration, switching the device to the other configuration, and performing a suitable stretch in that other configuration. The method may include removing the device from a storage configuration before use or placing the device into a storage configuration after use. The seat of the device may be supported in whole or part on a floor or ground surface when in use.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

1. A stretching device comprising:
a base;
a back, the back being pivotable with respect to the base;
an actuator and having a piston that moves with respect to the base, the piston being coupled to the back when the stretching device is in a pushing configuration and decoupled from the back when the stretching device is in a pulling configuration; and
a controller operably coupled to the actuator, the controller configured to direct the actuator to extend and retract the piston,
wherein, when the actuator is in the pushing configuration, extension of the piston causes a pivotal pushing motion of the back relative to the base, and
wherein, when the actuator is in the pulling configuration, the piston moves with respect to the base without causing pivotal motion of the back relative to the base.

2. The stretching device of claim 1 wherein the back comprises a central column hingedly coupled to the base.

3. The stretching device of claim 2, including at least one pad coupled to the central column.

4. The stretching device of claim 1, including a carriage configured to be removably coupled to the actuator, the carriage being coupled to the actuator when the stretching device is in the pushing configuration and being decoupled from the actuator when the stretching device is in the pulling configuration.

5. The stretching device of claim 4, the base including a conduit, the carriage including a rider, the rider being captured in a slot of the conduit.

6. The stretching device of claim 5, including an arm connected at one end to the rider and at another end to the back.

7. The stretching device of claim 1 further comprising:
a first pad disposed on a first side of the channel; and
a second pad disposed on a second side of the channel opposite the first side.

8. The stretching device of claim 7, the first and second pads being unsupported.

9. A kit comprising the stretching device of claim 1 and a foot pad attachment having a portion that retracts as the piston retracts in the pulling configuration, and a connector securable to the foot pad attachment and able to be operably coupled to the piston.

10. The kit according to claim 9, the connector comprising a strap.

11. The kit of claim 10, wherein the foot pad attachment comprises:
a support bar configured to removably couple to the strap;
a first foot retainer pivotably coupled to the support bar; and
a second foot retainer pivotably coupled to the support bar.

12. A kit comprising the stretching device of claim 1 and a split stretch attachment having a portion that retracts as the piston retracts in the pulling configuration.

13. The kit according to claim 12, the split stretch attachment having a pivot point, a first arm coupled to the pivot point, a second arm coupled to the pivot point, and first and second retainers connected respectively to the first and second arms, wherein the split stretch attachment is configured to convert retraction of the piston into a pivoting motion of the first arm and the second arm around the pivot point.

14. A kit comprising the stretching device of claim 1 and a bracket configured for mounting a massage device to the back of the stretching device.

15. The kit according to claim 14, the bracket comprising at least one securement strap.

16. A kit comprising the stretching device of claim 1 and a heat and vibration pad configured for removable mounting to the stretching device.

17. The kit of claim 16 comprising at least one strap engaging an end of the heat and vibration pad.

18. A stretching device comprising:
a base;
a back, the back being pivotable with respect to the base;
an actuator having a housing pivotably coupled to the base and a piston configured for coupling to the back when the device is in a pushing configuration and configured for positioning within a channel of the base when the device is in a pulling configuration; and
a controller operably coupled to the actuator, the controller configured to direct the actuator to extend and retract the piston from the housing,
wherein, when the device is in the pushing configuration, operation of the actuator causes pivotal motion of the back relative to the base, and
wherein, when the device is in the pulling configuration, operation of the actuator causes relative linear motion of the piston within the channel.

19. A stretching method comprising:
providing a stretching device, the device having a base, a back pivotable with respect to the base, an actuator, and a controller operably coupled to the actuator, and a seat, the seat being unsupported, the device being operable in a pushing configuration in which a piston of the actuator is coupled to the back and causes a pivotal pushing movement of the back relative to the base, and a pulling configuration in which a piston of the actuator causes retraction of a portion of the device between the legs of a user, the seat being configured to accommodate such retraction;
sitting on the seat of the device while the seat is resting on a floor or ground surface; and
actuating the controller to cause a pushing or pulling stretch via either a pivotal pushing movement or a retraction.

20. A stretching device according to claim 1, including an arm operably connecting the actuator to the back when the stretching device is in a pushing configuration but not when the stretching device is in a pulling configuration.

21. A stretching device according to claim 1, the base including a channel, the piston translating within the channel when the device is in a pushing configuration and when the device is in a pulling configuration.

22. A stretching device according to claim 1, the base having a conduit that defines a channel, the actuator disposed within the conduit and having a piston that translates with respect to the channel, wherein, when the actuator is in the pulling configuration, the piston translates within the channel without causing pivotal motion of the back relative to the base.
